(19) United States
(12) Patent Application Publication
(10) Pub. No.: US 2003/0234550 A1
(43) Pub. Date: Dec. 25, 2003

(54) Traveling console

(76) Inventors: Vincent L. Brooks, Troy, MI (US); Lejuan L. Richardson, Detroit, MI (US); Sherry N. Phillips, Mayville, MI (US); Frank X. Kreiling, Bloomfield Hills, MI (US)

Correspondence Address: CHUCK VEENSTRA, ESQ., DELPHI TECHNOLOGIES, INC., Legal Staff, Mail Code: 480-414-420, P.O. Box 5052, Troy, MI, 48007-5052, US

(21) Appl. No.: 10/178,864

(22) Filed: Jun. 24, 2002

(51) Int. Cl. B60N 3/00

(52) U.S. Cl. 296/24.1

(57) ABSTRACT

A method and apparatus for repositioning a display device in the passenger compartment of a vehicle is disclosed. The method and apparatus includes securing the display device to a console assembly, the console assembly configured to deploy the display device for viewing and to stow the display device when not in use. The console assembly is mounted to a movement assembly. The movement assembly is configured to allow translation of the console assembly within the passenger compartment between a front and a rear portion of the passenger compartment, wherein the display device is viewable from the front and rear portions. The console assembly comprises at least two sections being movable and slidable in the front-rear direction of the vehicle independent of each other. One of the two sections includes a pivotally retractable armrest.

### BACKGROUND

Vehicle interiors typically include front passenger seats and rear passenger seats positioned behind the front seats. These passenger seats can either be individual bucket type seats or bench type seats. A number of other interior components are usually mounted directly or in close proximity to these seats. The components can include pivotal and stationary armrests, seat belts, headrests, cup holders, and storage console assemblies.

The storage console assemblies are typically positioned in the center of the bench type seats or between a pair of bucket type seats. Accordingly, these console assemblies are typically called center console assemblies. The consoles usually have at lease one storage compartment with a pivotal lid for opening and closing the compartment. The pivotal lid can also act as an armrest. The storage compartment is utilized for storing any number of items such as portable phones, compact discs, pens, note pads, or the like. The center console assemblies known in the art are either pivotally mounted to the bench type seats or fixedly secured to a floor of the vehicle interior between the bucket type seats.

Most commonly, the center consoles are part of a modular unit which also includes a transmission shift lever, parking brake, mirror controls, and the like. Hence, the center consoles are normally and fixedly deployed within a vehicle and, more particularly, are typically deployed in close proximity to the driver's “position” or seat. The consoles are adapted to removably contain and/or store items and/or goods and are further adapted to allow the goods to be selectively utilized within the vehicle. Typically, these consoles occupy one or more vehicle areas or regions which normally contain and/or include a passenger seat. While it is desirable to have or provide a relatively large amount of console type storage space within the vehicle, it is not usually or typically desirable to reduce the amount of vehicle seating space, since the amount of such seating space limits the number of passengers that may comfortably reside within the vehicle. The amount of storage space and/or the size of the provided console is therefore typically limited by the amount of passenger seating space which is desired to be relinquished or “sacrificed” in order to provide such storage space.

Moreover, since the vehicle storage consoles are typically fixed within or stationarilly positioned within the vehicle, the consoles require a user to be seated or positioned in close proximity to the console in order to access or utilize the console. Hence, passengers residing within the “back seat” or the rear of the passenger compartment do not have ready access to the console. The stationary positioning of the console within the vehicle thereby limits the overall utility of the console.

Therefore it may be desirable to provide a storage console in a vehicle having modular accessory compartments that can be easily moved, repositioned or rearranged by the occupants of the vehicle for greater access to the storage console.

### SUMMARY

A console assembly for a vehicle having at least a pair of front seats comprising: a movement assembly extending in a front-rear direction of the vehicle between the front seats and extending to a position behind the front seats. A center console assembly comprises at least two sections mounted on the movement assembly, wherein at least one of the two sections is movable and slidable in the front-rear direction of the vehicle independent of the other of section. The center console assembly is adapted to receive a first display device viewable from the front seats and the position behind the front seats. The center console assembly also includes a pivotally retractable armrest.

In an alternative embodiment, a method is disclosed for repositioning a display device in the passenger compartment of a vehicle. The method includes securing the display device to a console assembly configured to deploy the display device for viewing and to stow the display device. The console assembly also includes a pivotally retractable armrest. The method further includes mounting the console assembly to a movement assembly configured to allow translation of the console assembly within the passenger compartment between a front and a rear portion of the passenger compartment, wherein the display device is viewable from the front and rear portions.

### BRIEF DESCRIPTION OF THE DRAWINGS

FIG. 1 is a schematic plan view of a passenger area of a vehicle seat structure having three rows of seats with a console assembly slidable therebetween;

FIG. 2 is a schematic plan view of another vehicle seat structure having two rows of seats with three sections of the console assembly of FIG. 1 disposed in three different positions in the passenger area;

FIG. 3 is a side view of the console assembly of FIGS. 1 and 2 on a movement assembly disposed in the passenger area;

FIG. 4 is a perspective view of an exemplary console assembly having a first display device incorporated in a pivotally retractable armrest and in operable communication with a computer;

FIG. 5 is a perspective view of an alternative embodiment of the console assembly in FIG. 4 illustrating the armrest in an extended position;

FIG. 6 is a side view of another alternative embodiment of the console assembly in FIG. 4 illustrating the pivoting armrest in the extended position and a position usable as an armrest with the first display device retractably disposed therein;

FIG. 7 is a perspective view of a console box section of the console assembly illustrating a second display device incorporated therein;

FIG. 8 is a side view of the console assembly of FIGS. 1 and 2 disposed in a front passenger area;

FIG. 9 is a side view of the console assembly of FIG. 8 disposed in a rear passenger area;

FIG. 10 is a side view of the console assembly of FIG. 8 with the console box section of the console assembly disposed in the rear passenger area; and

FIG. 11 is a side view of the console assembly of FIG. 9 with a first section thereof shown removed and disposed in the front passenger area.

### DETAILED DESCRIPTION

The following description is merely exemplary in nature and is in no way intended to limit the invention or its application or uses. In the following description, the terms, “front”, “rear”, “left”, “right”, “upper” and “lower,” denote respective directions as viewed from a vehicle operator or driver in the vehicle traveling direction. Likewise, use of the terms “first” and “second” are only identifiers and not intended to illustrate a sequence, position, etc.

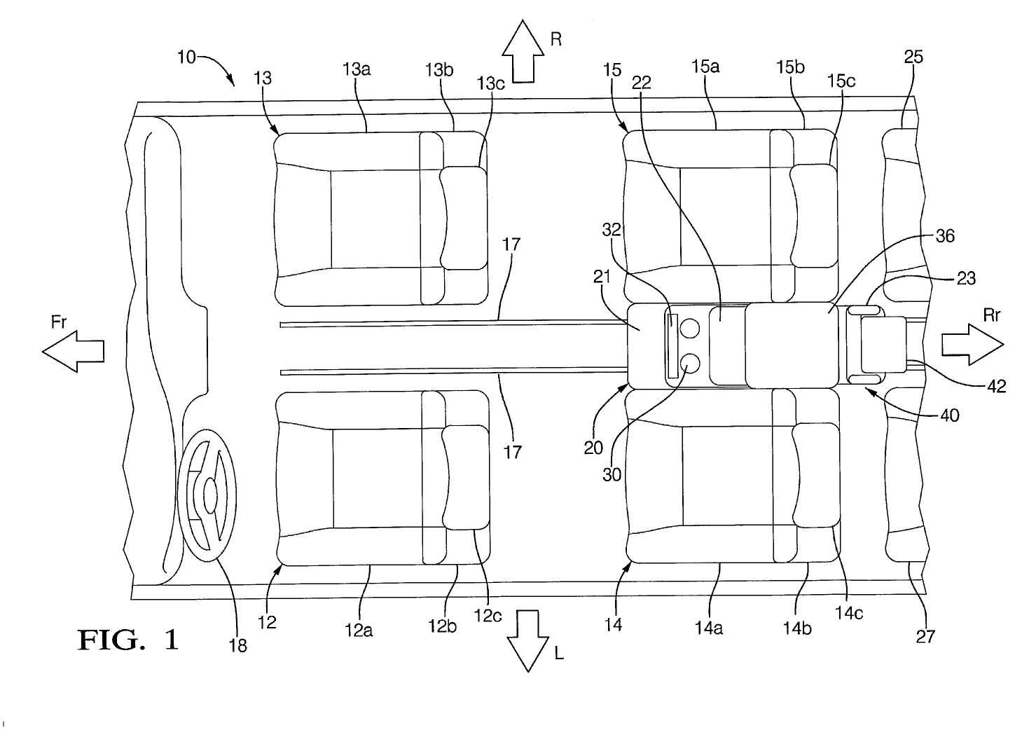

FIG. 1 is a schematic plan view of vehicle seating 10 according to one exemplary embodiment of the present disclosure, which comprises a front left seat 12, a front right seat 13 for the vehicle driver, a rear left seat 14 and a rear right seat 15. Two parallel rails 17 are disposed through the front and rear seat rows between the left seats 12, 14 and the right seats 13, 15, and a center console assembly 20 is provided for sliding movement on and along the rails 17. Console assembly 20 comprises a forward first section 21, a center second section 22, and a rearward third section 23. Sections 21-23 are modular fitting sections that slide on rails 17 in unison or individually independent of each other as described hereinafter. Reference numeral 18 denotes a steering wheel. FIG. 1 also illustrates rails 17 extending rearward between a second rear row behind the rear seat row. In this manner, console assembly may be translated to the rear of the vehicle or at least proximate seats 25 and 27 as illustrated in FIG. 1. It will be recognized that the vehicle seat 10 in FIG. 1 may be representative of the seating structure found in many minivans, sport utility vehicles and the like.

The front left seat 12 includes a seat part 12a, a back 12b pivotably attached to the seat part 12a, and a headrest 12c attached to the top of the back 2b for vertical movement relative thereto. The front right seat 13, rear left seat 14 and rear right seat 15 are constructed similarly to the front left seat 12; reference numerals 13a, 14a and 5a denote their respective seat parts, 13b, 14b and 15b denote their respective backs, and 13c, 14c and 15c denote their respective headrests. It will be understood that seats 25 and 27 in the second rear row may also include respective seat parts as in the above-mentioned front and rear seats.

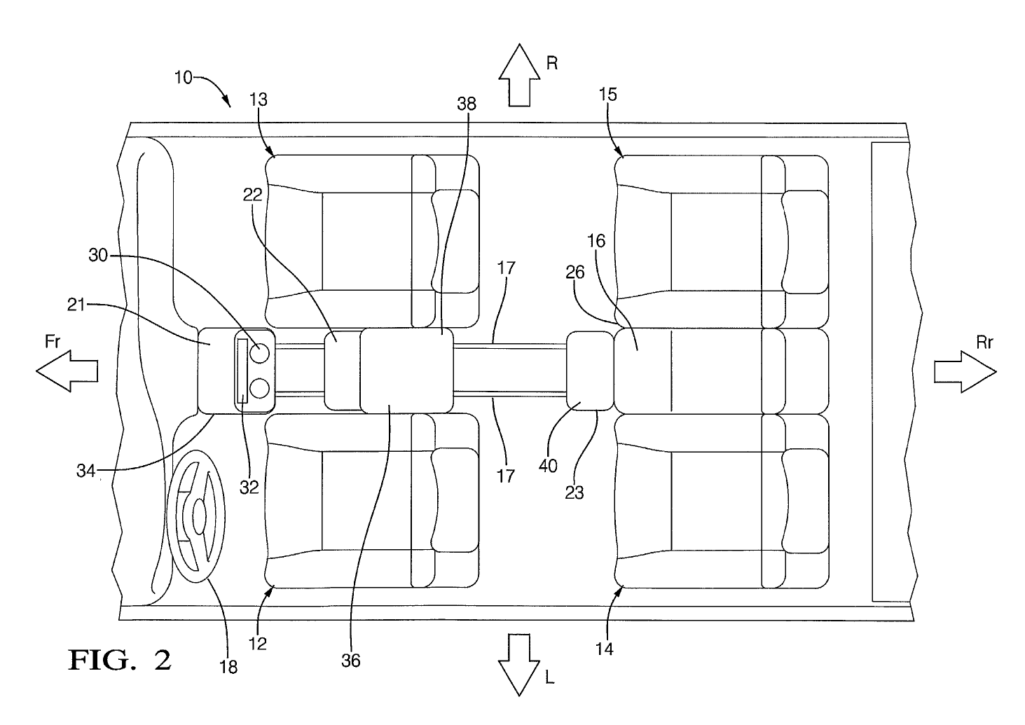

FIG. 2 is a schematic plan view of vehicle seating 10 according to an another exemplary embodiment of the present disclosure, which comprises a front left seat 12, a front right seat 13 for the vehicle driver, a rear left seat 14, rear right seat 15, and a rear middle seat 16 forming a rear bench seat 26. It will be recognized that this vehicle seating is very common among many passenger vehicles. Two parallel rails 17 are disposed through the front and rear seat rows and generally extend to rear bench seat 26 between the left seats 12, 14. Console assembly 20 is shown with each section 21-23 separated from one another and disposed over rails 17.

As best seen referring to FIGS. 1 and 2, first section 21 of console assembly optionally includes at least one cup holder 30, a cavity 32 configured therein for storage of articles such as, for example, sun glasses or change for roadway tolls. First section 21 of console assembly 20 further comprises a first storage area 34 for additional articles described later herein. Second section 22 may also include at least one cup holder (not shown). Second section 22 of console assembly further includes a pivotally retractable armrest 36 for use by an occupant seated either in the front row or any of the rear rows. Second section 22 optionally includes a second storage area 38 below armrest 36 described later herein. Third section 23 of console assembly optionally includes a third storage area 40 wherein a retractable drawer 42 is disposed therein for storing articles such as, for example, multi media games and media associated with such games or similar devices.

It will also be recognized by one skilled in the pertinent art that although two rails 17 have been shown in FIGS. 1 and 2 as an interface to employ mounting and slidable engagement between within the vehicle passenger area, many other movement assemblies may be employed for mounting and providing slidable engagement between the console assembly and the vehicle passenger area. For example a single track may be mounted within the passenger area and the console assembly may have rollers depending from a lower surface thereof that engage the track for mounting and sliding within the track affixed to the vehicle.

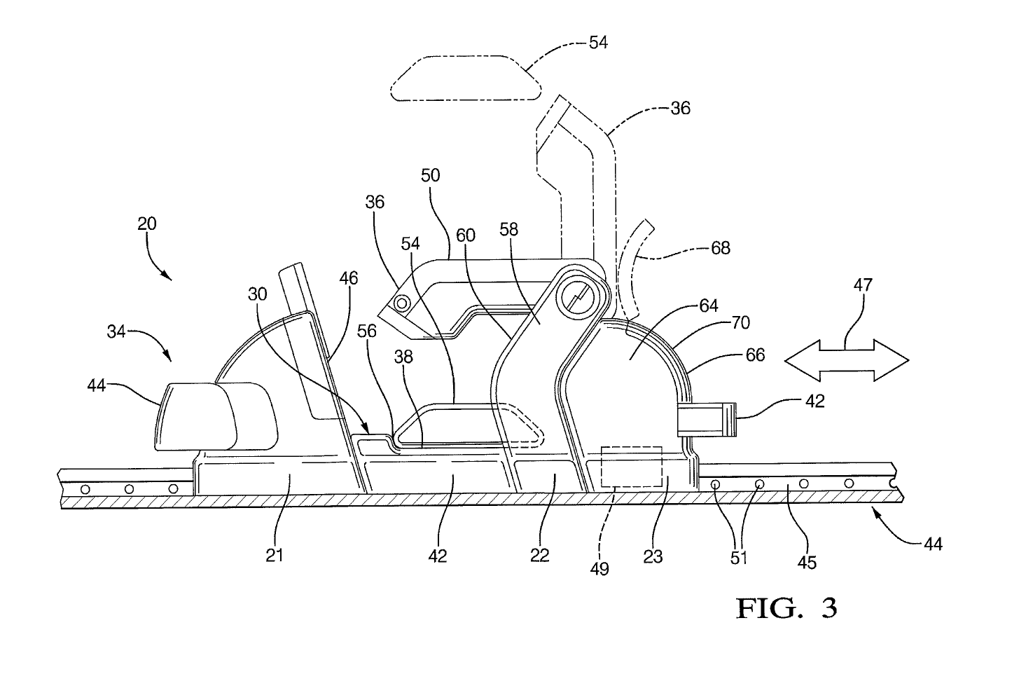

FIG. 3 is a side sectional view showing a console assembly comprising four sections 21-23 and 42 slidably mounted to a movement assembly 44 discussed above. Movement assembly 44 may include a pair of tracks or grooves 45 which are disposed upon the floor of the passenger compartment, substantially along the longitudinal axis of symmetry of the vehicle, and which movably receive wheels or roller members which are disposed upon the lower surface of each section 21-23 and 42. Particularly, the rollers are movably disposed within track 45 while the rollers are movably disposed within track 45. In one non-limiting embodiment of the invention, the rollers are substantially identical and tracks or grooves 45 are substantially identical. Roller members or wheels cooperate with tracks 45 to allow the console assembly 20 to be selectively moved within the vehicle in the direction which is indicated by arrow 47, thereby allowing the console assembly 20 to be selectively used by passengers within the front portion and/or the rear portion of the passenger compartment and increasing the overall utility of the console assembly 20. A releasable locking mechanism 49 is incorporated with each section 21-23 and 42 for engagement with at least one of a plurality of stopper holes 51 arranged in the longitudinal direction of at least one track 45 at equal intervals. Locking mechanism 49 may take the form of a pin (not shown) that is biased to engage track 45 and configured such that when the pin is aligned with a stopper hole 51, the pin slides through the hole locking a corresponding section 21-23, 42 in place. Locking mechanism may be configured in a number ways with a corresponding engagement means disposed on track 45 as known in the pertinent art, such as a biased lever to engage a corresponding tooth or slot disposed on the track 45. In other non-limiting embodiments, tracks 45 may comprise conventional seat type tracks or some other type of slide out receptacle 44 or mechanism which allows console 20 to be movably disposed within vehicle and which is generally and longitudinally disposed within the passenger compartment and which extends between the front portion and the rear portion.

Still referring to FIG. 3, first section 21 includes first storage area 34 having a slide out receptacle 43 for use as a first storage bin. In an exemplary embodiment, receptacle 43 is adapted as a tissue receptacle that may be slidably removed from the front of first section 21 for access thereof. Access is granted to receptacle 43 for retrieval or replacement of tissue therein. A rear of first section 21 optionally includes a docking/charging station 46 for a personal digital assistant (PDA) or navigational system (handheld/portable global positioning system GPS) 48 (FIG. 5) or other similar device. In an alternative embodiment, station 46 may be configured for receiving a flip out display device 50 that is in operable communication with a vehicle installed navigation system or mobile productivity center (MPC) (not shown). A MPC is commercially available from Delphi Automotive and allows a cell phone, PDA and other electronic communication devices to be installed and interfaced with vehicle installed computers for allowing hands free communication and navigation allowing the driver to concentrate on driving with both hands on steering wheel 18.

First section 21 may operatively connect with second section 22 of console assembly 20 having a section 24 intermediate section 21 and 22. As shown, section 24 is independent of sections 21 and 22. However, it will be recognized that section 24 may be part of section 21 having at least one cup holder 30 disposed therein that allows suitable access thereto when armrest 36 is in a horizontal position to allow an occupant to use the armrest 36 as intended without denying access to a cup disposed in a cup holder 30. Alternatively, section 24 may be incorporated with second section 22 having armrest 36. In this manner, when arm rest is shown substantially in the vertical position and a seat cushion 54 is disposed on an upper surface 56 of section 24, second section 22 and section 24 provide center seating for an occupant. Seat cushion 54 is shown removed in FIG. 3 exemplifying second storage area 38 beneath seat cushion 54. When armrest 36 is pivotally extended upright to provide center seating, it is preferable that padding is disposed on the armrest where the back of an occupant would rest. Armrest 36 is attached to a armrest support member 58 for pivotal movement relative thereto in the front-rear direction. In addition, it is preferred that armrest 36 pivotally extends from an armrest support member 58 comprising two legs 60 and 62 that create an obtuse angle therebetween for adding strength to the armrest support 58 when a moment is applied at the pivot point 59 via armrest 36. This moment is contemplated with the weight of an occupant resting their back against the armrest 36 when extended.

Referring to FIGS. 3 and 7, third section 23 includes a console box 64 providing third storage area 40 therein. The console box 64 includes a housing 65, a console door 70 provided on a surface of the housing 65 facing the center rear, drawer 42 is provided below console door 70, and a receptacle portion 40 provided within the housing 65. Front facing portion of housing 65 of console box is configured to be received in a cavity formed by legs 60 and 62 of armrest support member 58 creating the obtuse angle. The rear of console box 64 includes the slide out drawer 42 for access to articles stored therein. The rear of console box 64 is to adapted to receive a multimedia player 66. Multimedia player 66 includes console door 70 pivotably provided on a surface thereof facing rearward to function as a pivotally retractable display 68 when door 70 is opened. Multimedia player 66 includes video player (e.g., DVD) and game players, such as SONY PLAYSTATION (PS2)®, NINTENDO®, SEGA®, and the like. Drawer 42 may be used to store videos (e.g., DVD's) and game controllers for a corresponding multimedia player 66 employed in console box 64. In addition, preferred embodiments include adapting either console box 64 or multimedia player 66 to allow removal of the multimedia player 66 from console box 64 for preventing theft thereof.

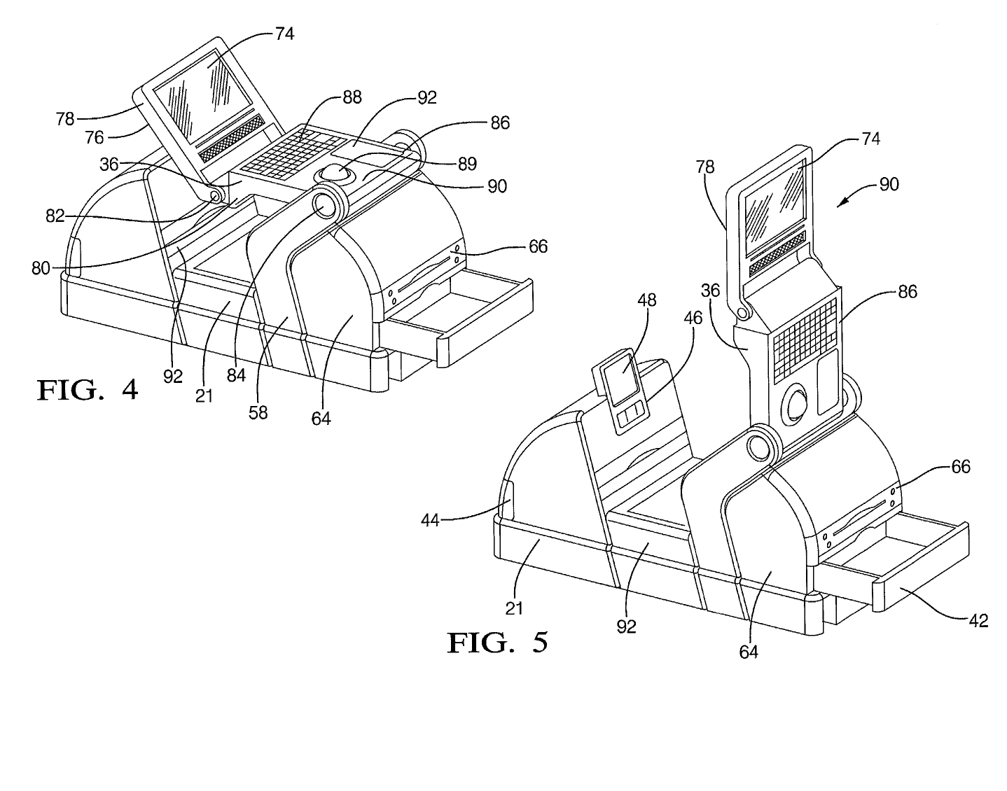

Referring to FIG. 4, an exemplary embodiment of a console assembly 20 having armrest 36 adapted to include a pivotally retractable display device 74 is shown. Armrest 36 includes a first section 76 comprising display device 74, such as a video monitor, on one side and a padded surface 78 on the opposite side suitable for an armrest. First section 76 is pivotally attached to a second section 80 via a pin 82 at one end of section 80 and pivotally attached to armrest support member 58 via a second pin 84 at an opposite end of section 80. First section 76 is shown with phantom lines in a closed position and with solid lines in an open position exposing display device 74. Armrest 36 optionally includes a computer (not shown) that is in operable communication with display device 74. Alternatively, display device 74 may be in operable communication with multimedia player 66 disposed in console box 64. Furthermore, display device 74 may be in operable communication with a navigation system or MPC employed in the vehicle. In an exemplary embodiment as shown in FIG. 4, second section 80 is configured to receive an input device 86 in operable communication with display device 74. Input device 86 may include a keyboard 88 and a trackball mouse 89. Input device may further incorporate a storage cavity 91 therein for additional storage within armrest 36 of, for example, office supplies such as paper clips, pen, or pencil, and the like.

Referring to FIG. 5, an alternative embodiment shown in FIG. 4 includes section 80 of armrest 36 optionally adapted to receive input device 86 that is configured as a personal laptop computer 90. In this configuration, first section 76 includes display device 74 of laptop computer 90 while second section 80 of armrest 36 includes input device 86 as well as the processing capabilities of computer 90. Laptop computer 90 is shown with armrest 36 in an upright position with display device proximate the headrests within the passenger area. In this manner, occupants may employ computer 90 for viewing a DVD or surfing the Internet via a wireless connection to computer 90. Referring to FIGS. 4 and 5, first section 21 is optionally configured to receive a printer 92 therein that is in operable communication with computer 90.

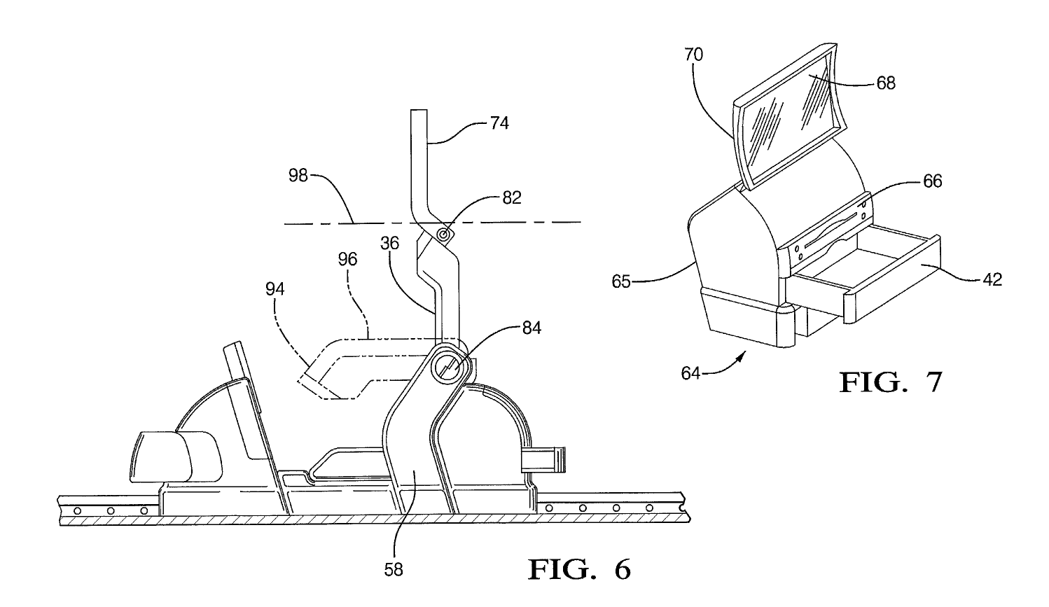

Referring to FIG. 6, console assembly 20 is shown employing an alternative embodiment of armrest 36 wherein display device 74 is pivotally retractable within an end portion 94 facing the front of armrest 36. Opposite display device 74 is padded surface 78 that forms a substantially flush surface with a top surface 96 of armrest 36 when display device is in a closed position. When armrest 36 is pivoted up and to the rear about pin 84 and display device 74 is pivotally retracted about pin 82 to an open position, it can be seen that display device 74 is disposed above a belt line in the vehicle indicated by line 98.

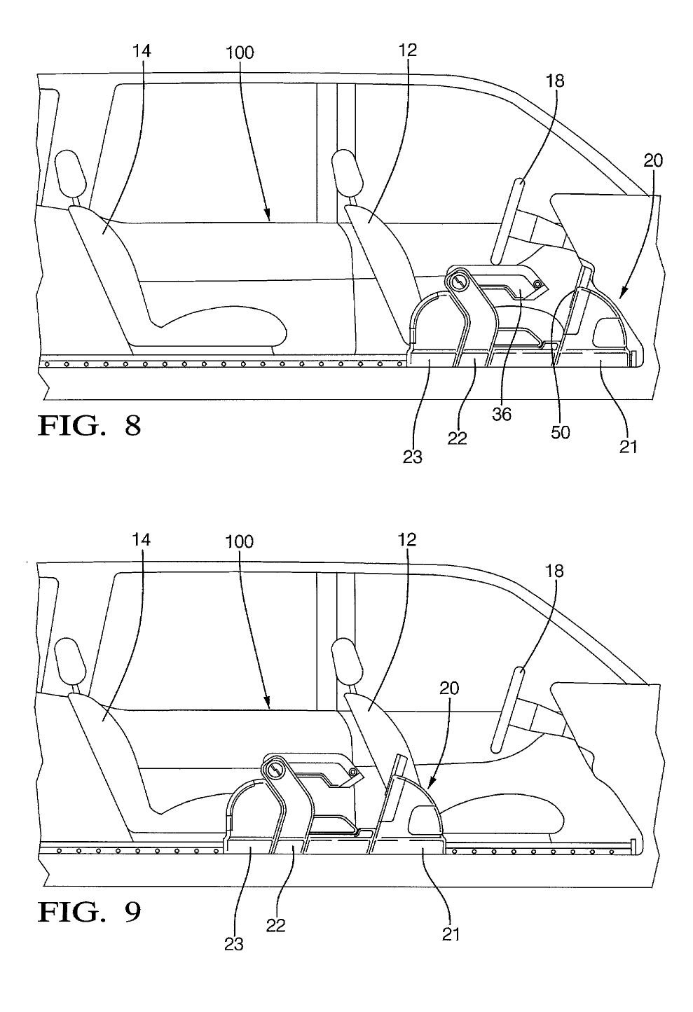

Characteristic operation of the above-mentioned vehicle seat structure 10 will now be described with reference to FIGS. 8-11.

FIGS. 8 and 9 are views explanatory of characteristic operation of the vehicle seat structure 10 according to an exemplary embodiment. Specifically, FIG. 8 shows a case where sections 21-23 of console assembly 20 are contiguous and disposed in an extreme forward position. In this position, front seat occupants may use pivotally retractable armrest 36 and view flip out display 50 depending from first section 21 and may view display device 74, for example, navigational assistance provided thereon. Also, the console assembly provides a throughway 100 in the rear passenger area. In this case, when armrest 36 is pivotally moved to the rear and upright position, occupants in the rear seat row may easily view display device 74. In addition, it is contemplated that a center seat may be formed between seats 12 and 13 to provide additional seating. Alternatively, seats 12 and 13 having set cushion 54 therebetween together constitute a bench seat to at least prevent objects falling between seats 12 and 13 when console assembly is forwardly positioned having armrest in the upright position.

In FIG. 9, console assembly 20 is moved from the forward position in FIG. 8 to a rear position. In this case, throughway 100 is possible when armrest 36 is pivoted to the rear upright position. In this rearward position, console box 64 is accessible to rear seat occupants in seats 14 and 15.

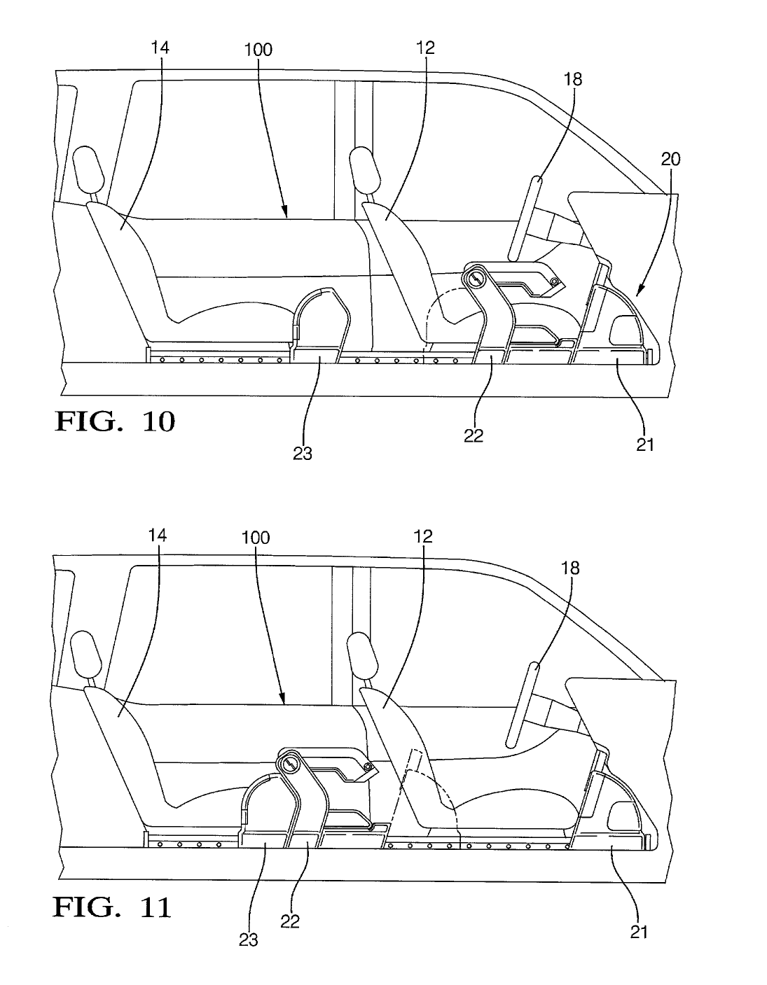

In FIG. 10, the first and second section 21, 22 center seat 10 have been moved between the front left and right seats 12 and 13 from the rear passenger area leaving console box section 23 in the rear passenger area. In this case, it is desirable that the console box section 23 be used in the following manner because a larger empty opening or gap forming throughway 100 is created without second section 22. Moreover, the rear seat occupants can access console box section 23, while front seat occupants can use armrest 36 on second section as well as gaining access to first section 21.

In FIG. 11, the second section 22 is moved to the rear next to console box section 23 while first section 21 remains between front left and right seats 12 and 13. The armrest 36 is pivoted forward to the horizontal position so as to narrow throughway 100. In this manner, a laptop computer 90 incorporated in armrest 36 as illustrated in FIGS. 4 and 5 can be conveniently used because the console box section 23 and second section 22 provided with the armrest 36 can be moved to and used between the rear left and right seats 14 and 15.

As set forth above, the vehicle seat structure 10 according to the exemplary embodiments described herein are arranged to allow the modular console assembly 20 to be freely moved from the front seat row to the rear seat row and vice versa. This arrangement provides for a variety of console combinations that would be suitably used for various cases, such as where two persons are seated on each of the seat rows, where three persons are seated on the front seat row with two persons seated on the rear seat row and where two persons are seated on the front seat row with three persons seated on the rear seat row.

In the case where two persons are seated on the front seat row, the console assembly 20 can be transformed for use as a retractable armrest or table. In the case where two persons are seated on the rear seat row, the console box section 23 of console assembly 20 can be used as a multimedia center. As a result, this vehicle seat structure 10 provides for an increased space efficiency in the vehicle, thereby improving the convenience, dwelling comfort and space efficiency of the vehicle while providing greater accessibility to components associated with the console assembly.

Further, by setting the armrest 36 of the console assembly 20 to the raised position for a reduced dimension in the front-rear direction of the vehicle, the center seat 10 can be moved to be placed snugly between, and in substantial alignment with, either the front and rear left and right seats 12-15 to thereby provide a bench seat for three people. This arrangement also permits a walk-through without requiring an increased distance between the front and rear seat rows, thereby improving the convenience, dwelling comfort and space efficiency of the vehicle.

So far, the console assembly 20 with the pivotable armrest 36 have been described as movably arranged in a vehicle including a pair of front and rear seat rows. However, the present invention is not so limited; for example, the console assembly may be movably arranged in a vehicle including three seat rows. Furthermore, it is contemplated the console assembly may be movably arranged to extend to a tailgate portion of the vehicle to allow viewing of the display device 74 when armrest 36 is in the upright position. In this manner, display device may be view able outside the vehicle through the rear window or with a tailgate portion open at a function such as a tailgate party or when camping, for example.

In summary, the present disclosure provides a vehicle seat structure which permits a variety of console combinations and improved convenience, dwelling comfort, accessibility, and space efficiency of the vehicle.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A console assembly for a vehicle having at least a pair of front seats comprising:
a movement assembly extending in a front-rear direction of the vehicle between the front seats and extending to a position behind the front seats; and
a center console assembly mounted on said movement assembly, said center console assembly comprising at least two sections, wherein at least one of said two sections being movable and slidable in the front-rear direction of the vehicle independent of the other of said two sections, said center console assembly including a pivotally retractable armrest, said center console assembly adapted to receive a first display device viewable from the front seats and said position behind the front seats.

2. The console assembly of claim 1 wherein said one of two sections includes:
a console box provided rearwardly of said center console assembly and, said console box being movably mounted on said movement assembly and slidable in the front-rear direction of the vehicle independently of said center console assembly,
wherein said console box provide storage and is designed to be at least receivable in an area which is defined right behind a rearwardly inclined rear surface of respective seatbacks of the front seats when viewed from a transverse direction of the vehicle, said console box being accessible to a passenger seated behind the front seats.

3. The console assembly of claim 2 wherein said console box is adapted to receive a multimedia player, said multimedia player having a console door pivotably provided on a surface thereof facing rearward to function as a pivotally retractable second display device.

4. The console assembly of claim 2 wherein said storage includes a retractable bin configured in said console box.

5. The console assembly of claim 1 wherein at least one cup holder is provided on said center console assembly.

6. The console assembly of claim 1 wherein said first display device is incorporated in said armrest providing a pivotally retractable said first display device in such a manner that said first display device is movable into and out of said armrest.

7. The console assembly of claim 6 wherein said pivotally retractable armrest allows first display device positionable in two different viewable vertical positions.

8. The console assembly of claim 1 wherein said first display device is in operable communication with at least one of, including combinations of at least one of the following:
a video player;
a DVD player;
a computer; and
a navigation system.

9. The console assembly of claim 8 wherein one of and including combinations including at least one of the following is operably disposed in said armrest:
a video player;
a DVD player;
a computer; and
a navigation system.

10. The console assembly of claim 1 wherein said movement assembly includes at least one rail having a row of stopper holes arranged in the longitudinal direction of said at least one rail at equal intervals, said center console assembly and said console box including a releasable locking mechanism configured to selectively fit in at least one corresponding said stopper hole in said at least one rail to position and lock each of said center console assembly said console box at a desired location on said at least one rail.

11. The console assembly of claim 1 wherein said center console comprises:
a first section having a first storage area; and
a second section, said second section including said armrest,
wherein said first and second sections are movably mounted on said movement assembly and slidable in the front-rear direction of the vehicle independent of each other.

12. The console assembly of claim 11 wherein said movement assembly includes at least one rail having a row of stopper holes arranged in the longitudinal direction of said at least one rail at equal intervals, each of said first section, said second section, and said console box including a releasable locking mechanism configured to selectively fit in at least one corresponding said stopper hole in said at least one rail to position and lock each of said first section, said second section and said console box at a desired location on said at least one rail.

13. The console assembly of claim 11 wherein said first section includes at least one cup holder.

14. The console assembly of 11 wherein said first storage area includes a removable tissue receptacle.

15. The console assembly of claim 11 wherein said first storage area is configured to operably receive and provide a pivotally retractable area for receiving one of a third display device and a communications device.

16. The console assembly of claim 15 wherein said one of said third display device and said communications device is movable into and out of said storage area for portable usage thereof.

17. The console assembly of claim 16 wherein said one of said third display device and said communications device includes one of, and including combinations of at least one of:
a personal digital assistant (PDA);
a mobile productivity center (MPC); and
a mobile telephone.

18. The console assembly of claim 11 wherein said second section includes a movable seat cushion providing a second storage area beneath said seat cushion.

19. The console assembly of claim 18 wherein said second section having said armrest is configured to provide a center seating portion when said armrest is pivoted upward.

20. The console assembly of claim 11 wherein said second section includes said armrest pivotally depending from an arm support, said arm support configured having a first leg depending from a second leg creating an obtuse angle therebetween.

21. The console assembly of claim 20 wherein said obtuse angle is adapted to provide strength in said second section relative to a moment applied to said armrest on either side thereof.

22. An assembly for use within a vehicle of the type having a passenger compartment with a front and a rear portion, said assembly comprising: a movement assembly which is longitudinally disposed within said passenger compartment between said front and said rear portion; and a console having at least one display device incorporated therein viewable from said front and rear portions, said console allows at least one display device to be selectively placed relative to said console and which is coupled to said movement assembly and which is selectively movable, by use of said movement assembly, between said front and said rear portion of said passenger compartment.

23. The assembly of claim 22 wherein said movement assembly comprises at least one rail.

24. The assembly of claim 22 wherein said at least one rail comprises a pair of tracks.

25. The assembly of claim 22 wherein said console includes a plurality of rollers which are each movably disposed within one of said pair of tracks.

26. The assembly of claim 25 wherein said rollers cooperate with said pair of tracks to allow said console to be selectively movable within said passenger compartment.

27. The assembly of claim 22 wherein said console includes a retractable armrest having a first display device of said at least one display device disposed therein, said retractable armrest is selectively movable to an operative position in which said first display device is disposed above a beltline in said passenger compartment.

28. The assembly of claim 22 wherein said armrest is adapted to selectively store said first display device therein and pivotally retract therefrom for viewing.

29. The assembly of claim 28 wherein said first display device is in operable communication with at least one of, including combinations of at least one of the following:
a video player,
a DVD player,
a computer, and
a navigation system.

30. The assembly of claim 29 wherein one of and including combinations including at least one of the following is operably disposed in said armrest:
a video player;
a DVD player;
a computer; and
a navigation system.

31. The assembly of claim 30 wherein said console is slidable to at least one of a second row of rear seats section and proximate a rear entry section of the vehicle for viewing from the respective section of the vehicle.

32. A method for repositioning a display device in the passenger compartment of a vehicle, the method comprising:
securing the display device to a console assembly, the console assembly configured to deploy the display device for viewing and to stow the display device, said console assembly having a pivotally retractable armrest; and
mounting the console assembly to a movement assembly, said movement assembly configured to allow translation of said console assembly within the passenger compartment between a front and a rear portion of the passenger compartment, wherein the display device is viewable from said front and rear portions.

33. The method of claim 32 wherein said console assembly includes a first section having said armrest and a second section, wherein said first and second sections being movably mounted on said movement assembly and slidable in the front-rear direction of the vehicle independently of each other, at least one of said first and second sections having the display device secured therein.

34. The method of claim 33 wherein the display device is incorporated in said armrest providing a pivotally retractable display device in such a manner that the display device is movable into and out of said armrest, in stowed and deployed positions, respectively, and said pivotally retractable armrest allows the display device positionable in two different viewable vertical positions.

35. The method of claim 32 wherein the display device is in operable communication with at least one of, including combinations of at least one of the following:
a video player,
a DVD player,
a computer, and
a navigation system.
